(19) United States
(12) Patent Application Publication
(10) Pub. No.: US 2025/0325954 A1
(43) Pub. Date: Oct. 23, 2025

(54) FLOW SYNTHESIS DEVICE

(71) Applicant: Panasonic Intellectual Property Management Co., Ltd., Osaka (JP)

(72) Inventors: TAICHI NAKAMURA, Osaka (JP); HIROAKI YOSHIDA, Osaka (JP)

(21) Appl. No.: 19/257,228

(22) Filed: Jul. 1, 2025

Related U.S. Application Data
(63) Continuation of application No. PCT/JP2023/043571, filed on Dec. 6, 2023.

(30) Foreign Application Priority Data
Jan. 26, 2023 (JP) 2023-010265

(51) Int. Cl. B01J 19/00; B01F 31/80; B01F 33/301; B01F 101/00; B01J 19/06; B01J 19/28

(52) U.S. Cl. CPC B01J 19/0093; B01F 31/84; B01F 33/3017; B01J 19/06; B01J 19/285; B01F 2101/2204; B01F 2215/0431; B01J 2219/00855; B01J 2219/0086; B01J 2219/00889; B01J 2219/1923

(57) ABSTRACT

A flow synthesis device that synthesizes a compound by mixing a plurality of fluids is provided. The flow synthesis device includes a raw material supply unit through which the plurality of fluids are supplied, a mixing channel portion in which the plurality of fluids supplied from the raw material supply unit are mixed to be a synthesized compound, a stagnation channel portion in which the synthesized compound stagnates, the stagnation channel portion being connected in series with a downstream end of the mixing channel portion, and a vibration applying mechanism that applies vibration to the mixing channel portion from a vertically lower side to a vertically upper side, the vibration applying mechanism being provided only to a part of a lower surface of the mixing channel portion.

### TECHNICAL FIELD

The present disclosure relates to a flow synthesis device that chemically reacts a plurality of fluids in a channel to produce a compound, such as particles.

### BACKGROUND ART

In recent years, efforts have been actively made to apply a so-called microreactor, which is a device for mixing fluids in a channel manufactured by micromachining technology or the like, to the biotechnology and medical fields and the like.

The characteristics of the microreactor include: (1) temperature control can be accurately and efficiently performed; (2) uniform mixing can be performed under a laminar flow; and (3) mixing proceeds rapidly because of a short diffusion length of a substance.

In recent years, the trend of applying a microreactor to a particle synthesis process on the order of nanometers by a liquid phase synthesis method leveraging these characteristics has been accelerated. In the case of synthesizing uniform particles, if the timing of nucleation or the particle growth time varies, the particle diameter varies. Therefore, it is necessary to control the processes of nucleation, particle growth, and aggregation.

In a conventional batch method in which fluids are mixed by mechanical stirring, it is difficult to stably produce particles having a uniform particle diameter in a certain amount due to variations in synthesis conditions such as uneven concentration and uneven temperature.

Therefore, by applying the microreactor to a flow synthesis device, it is possible to continuously synthesize monodisperse particles having a uniform particle diameter since mixing is performed quickly and uniformly at the phase of nucleation under the condition of precise temperature control and the reaction time can be kept constant at the phase of particle growth, the reaction time affecting the growth.

However, when particles are generated in the microchannel, the particles are bonded and deposited in the channel due to precipitation or aggregation of the particles, and the channel may be eventually clogged. Therefore, it may be difficult to continuously use the microreactor for a long time.

Therefore, in order to solve these problems, there is disclosed a method capable of stably producing particles having a uniform particle diameter by synthesis using a device including a mixing channel portion that mixes a plurality of fluids, a stagnation channel portion that is connected in series to the mixing channel portion and in which particles produced in the mixing channel portion are retained, a detection mechanism that detects a value of pressure in the stagnation channel portion, and a vibration applying mechanism that applies vibration only to the stagnation channel portion on the basis of a value detected by the detection mechanism (see, for example, PTL 1).

### CITATION LIST

### Patent Literature

PTL 1: Japanese Patent No. 5081845

### SUMMARY OF THE INVENTION

In an embodiment of the present disclosure, the flow synthesis device that synthesizes a compound by mixing a plurality of fluids is provided. The flow synthesis device includes a raw material supply unit through which the plurality of fluids are suppled, a mixing channel portion in which the plurality of fluids supplied from the raw material supply unit are mixed to be a synthesized compound, a stagnation channel portion in which the synthesized compound stagnates, the stagnation channel portion being connected in series with a downstream end of the mixing channel portion, and a vibration applying mechanism that applies vibration to the mixing channel portion from a vertically lower side to a vertically upper side, the vibration applying mechanism being provided only to a part of a lower surface of the mixing channel portion.

### BRIEF DESCRIPTION OF THE DRAWINGS

FIG. 1 is a schematic view illustrating the configuration of a flow synthesis device according to an exemplary embodiment.

FIG. 2 is a cross-sectional view illustrating the cross-sectional structure of a mixer in a flow synthesis device according to an exemplary embodiment as viewed in y1-y2 direction.

FIG. 3 is a top view of the x1 part of a mixer in a flow synthesis device according to the first exemplary embodiment.

FIG. 4 is Table 1 showing the synthesis conditions and evaluation results of Comparative Example and Example.

### DESCRIPTION OF EMBODIMENT

In the synthesis method using the device described in PTL 1, vibration is applied only to the stagnation channel portion that is separated in the downstream direction from the mixing channel portion. Therefore, the synthesis method can be applied to a material whose time from a nucleation phase to a growth phase in a particle formation process is sufficiently long, but cannot be applied to a material whose time from a nucleation phase to a growth phase is short.

The present disclosure has been made in view of the above, and an object of the present disclosure is to provide a flow synthesis device that is capable of stably producing particles having a uniform particle diameter even with a material whose time from a nucleation phase to a growth phase in a particle formation process is short.

The flow synthesis device according to the first embodiment is a flow synthesis device that synthesizes a compound by mixing a plurality of fluids, the flow synthesis device including a raw material supply unit through which the plurality of fluids are suppled, a mixing channel portion in which the plurality of fluids supplied from the raw material supply unit are mixed to be a synthesized compound, a stagnation channel portion in which the synthesized compound stagnates, the stagnation channel portion being connected in series with a downstream end of the mixing channel portion, and a vibration applying mechanism that applies vibration to the mixing channel from a vertically lower side to a vertically upper side, the vibration applying mechanism being provided only to a part of a lower surface of the mixing channel portion.

The flow synthesis device according to the second embodiment is that, in the first embodiment, each of the raw material supply unit and the mixing channel portion may have a cross section having a rectangular shape.

The flow synthesis device according to the third embodiment is that, in the first embodiment, the stagnation channel portion may have a larger cross-sectional area than a cross-sectional area of the mixing channel portion.

The flow synthesis device according to the fourth embodiment is that, in the first embodiment, the stagnation channel portion may be connected from the vertically lower side to the vertically upper side the downstream end of the mixing channel portion.

The flow synthesis device according to the fifth embodiment is that, in the first embodiment, each of the raw material supply unit and the mixing channel portion may have a channel width and a channel depth, and a ratio Z/Y may satisfies 1<Z/Y<10 when Y is in a range of 0.1 mm to 5 mm, where Y represents the channel width of each of the raw material supply unit and the mixing channel portion, and Z represents the channel depth of each of the raw material supply unit and the mixing channel portion.

The flow synthesis device according to the sixth embodiment is that, in the first embodiment, the vibration applying mechanism may include a vibration applying unit to apply the vibration, and the mixing channel portion may include a liquid reservoir having a cross section identical to a cross section of the vibration applying unit in shape as viewed in a direction intersecting a flow direction of the plurality of fluids, the liquid reservoir being provided above the vibration applying mechanism.

The flow synthesis device according to the seventh embodiment is that, in any of the first to sixth embodiments, the mixing channel portion may be defined by upper and lower inner surfaces and side inner surfaces of the mixing channel portion, and the side inner surfaces may have a larger surface roughness than a surface roughness of the upper and lower inner surfaces.

When the flow synthesis device according to an embodiment of the present disclosure is employed, particles having a uniform particle diameter can be stably produced even with a material whose time from a nucleation phase to a growth phase in a particle formation process is short.

Hereinafter, the flow synthesis device according to an exemplary embodiment of the present disclosure will be described with reference to the drawings. However, unless otherwise specified, the constituent elements, types, combinations, shapes, relative positions, and the like described in the exemplary embodiment are not intended to limit the scope of the present disclosure only thereto, and are merely illustrative examples.

### First Exemplary Embodiment

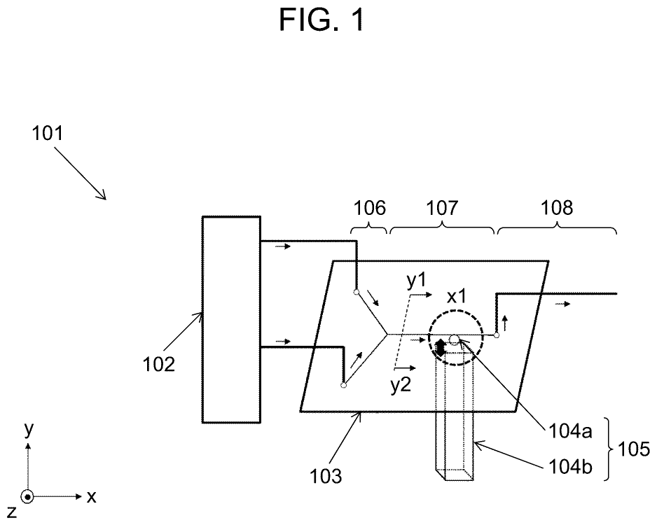

FIG. 1 is a schematic view illustrating the configuration of a flow synthesis device according to the first exemplary embodiment. For convenience, the plane of mixer 103 having a planar shape is indicated as the XY plane, the flow direction in mixing channel portion 107 is indicated as the X direction, and the vertically upper side is indicated as the Z direction.

In the first exemplary embodiment, flow synthesis device 101 is provided with raw material supply unit 106, mixing channel portion 107, and stagnation channel portion 108. In flow synthesis device 101, raw material supply unit 106 is to supply the plurality of fluids. In flow synthesis device 101, mixing channel portion 107 is to mix the plurality of fluids supplied from raw material supply unit 106 and synthesize the compound. Stagnation channel portion 108 is to stagnate the synthesized compound, stagnation channel portion 108 connected in series on the downstream side of mixing channel portion 107. Raw material supply unit 106 and mixing channel portion 107 constitute mixer 103 having a continuous surface. In addition, the lower surface of mixing channel portion 107 is provided with vibration applying mechanism 105 to apply vibration from the vertically lower side to the vertically upper side (in the Z direction). The plurality of liquids fed from liquid feeder 102 is passed through raw material supply unit 106, is mixed in mixing channel portion 107, and then generates nucleation of the compound. Further, in a series of processes where the liquids pass through stagnation channel portion 108, particle growth of the compound is promoted. In this manner, a particle-containing liquid is produced in flow synthesis device 101 and fed therethrough.

In flow synthesis device 101, the lower surface of mixing channel portion 107 is provided with vibration applying mechanism 105. As a result, it is possible to suppress adhesion and deposition of the particles nucleated in mixing channel portion 107 on the wall surface of mixing channel portion 107 and to stably produce particles having a uniform particle diameter.

Liquid feeder 102 and mixer 103, and mixer 103 and stagnation channel portion 108, are each connected by piping.

Vibration applying mechanism 105 has vibration applying unit 104a and vibration applicator 104b. Vibration applying mechanism 105 is placed in contact with the lower surface of mixing channel portion 107 of mixer 103 via vibration applying unit 104a.

Here, stagnation channel portion 108 is preferably connected from the vertically lower side to the vertically upper side on the downstream side of mixing channel portion 107. That is, the piping of stagnation channel portion 108 is preferably connected to mixer 103 vertically upward (in the Z direction). The reason will be described below.

In mixer 103, the cross-sectional area of the channel is preferably small in order to ensure mixing performance of the plurality of liquids in the channel.

On the other hand, in stagnation channel portion 108, the cross-sectional area of the channel is preferably large in order to cause particle growth and particle aggregation in the liquid due to the synthesis reaction in the passing process. However, the flow rate decreases due to the change in the cross-sectional area between mixing channel portion 107 and stagnation channel portion 108. For this reason, there is a problem that clogging is likely to occur due to deposition of grown particles or aggregates of particles in the portion switching from mixing channel portion 107 to stagnation channel portion 108.

As described above, stagnation channel portion 108 is connected from the vertically lower side to the vertically upper side on the downstream side of mixing channel portion 107. Specifically, the piping connecting mixer 103 and stagnation channel portion 108 extends vertically upward (in the Z direction). With such a configuration, the direction in which mixing channel portion 107 is switched to stagnation channel portion 108 (the Z direction) coincides with the vibration direction of vibration applying unit 104a, which is in contact with the lower surface of mixing channel portion 107 (the Z direction). As a result, vibration applied to the lower surface of mixing channel portion 107 can be easily propagated to the portion switching to stagnation channel portion 108 via the flowing liquid, and clogging in the switching portion can be easily suppressed.

In addition, in order to promote particle growth in the liquid by the synthesis reaction, stagnation channel portion 108 may be controlled to be in a thermostatic state with a thermostatic device such as an oil bath, an electric heater, or a microwave heating device as necessary (not illustrated).

Hereinafter, the members constituting flow synthesis device 101 according to the first exemplary embodiment will be described.

Liquid feeder 102 is capable of feeding a plurality of liquids, and is configured by, for example, a liquid feeding device such as a syringe pump, a plunger pump, a diaphragm pump, a tube pump, a Mohno pump, or a piezo pump.

Mixer 103, including raw material supply unit 106 and mixing channel portion 107, is capable of mixing a plurality of liquids in the channel, and has a continuous surface (for example, a plane). For example, mixer 103 is constituted by a member produced by bonding, laminating, and fixing a plurality of flat plates, as described later.

Vibration applying unit 104a is a ceramic ball having a size of φ2.5 mm. Vibration applicator 104b includes a laminated piezoelectric actuator with a pressurizing mechanism. Vibration applying mechanism 105 applies vibration at a frequency of 100 Hz to 40 kHz with vibration applicator 104b so that the lower surface of mixing channel portion 107 is displaced by 1 μm to 50 μm at a thrust of 150 N to 850 N via the contact point with the ceramic ball as vibration applying unit 104a.

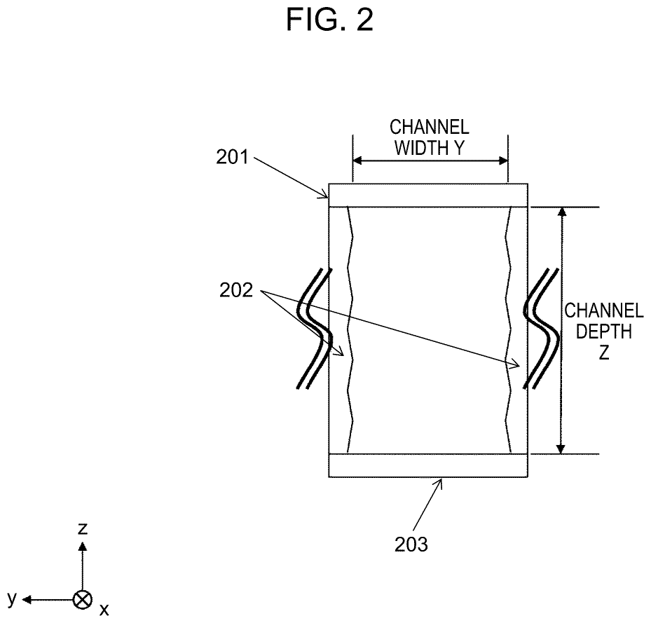

FIG. 2 is a cross-sectional view illustrating the cross-sectional structure of a mixer in a flow synthesis device according to the first exemplary embodiment as viewed in y1-y2 direction. The direction from the front to the back in the paper surface indicates the flow direction of the channel in mixing channel portion 107 (the X direction), and the direction from the top to the bottom in the paper surface indicates the vertical direction (the Z direction), which is the depth direction.

Mixer 103 is configured in a state in which channel plate 202 processed into a channel shape is bonded and laminated with glass plate 201 on the upper surface side and vibrating plate 203 on the lower surface side, and fixed with a ¼-28UNF bolt or the like (not illustrated).

Glass plate 201 on the upper surface side is preferably transparent in order to secure the visibility of the liquid flow state. Therefore, a sheet of quartz glass having a thickness of 3 mm is employed. However, glass plate 201 is not limited thereto, and SUS316L or the like may be used when visibility is not required.

As channel plate 202, a SUS316L plate having a thickness of 0.5 mm is employed in order to secure strength and chemical resistance, and processed into a channel shape by wire cutting so that channel width Y in the Y direction is 0.2 mm. Then, channel plate 202 is configured so that the cross section of the channel has a rectangular shape when the upper and lower surfaces thereof are bonded and laminated with glass plate 201 and vibrating plate 203 as described above.

Here, channel width Y is preferably small in order to secure the ability of mixing the plurality of liquids in the channel, and channel depth Z is preferably large in order to secure the settling time of the precipitated particles dispersed in the liquid due to vibration applied to vibrating plate 203 on the lower surface side as described later. From the viewpoint of balance with processing dimensions and the like, the ratio Z/Y preferably satisfies 1<Z/Y<10 when Y is in a range of 0.1 mm to 5 mm.

In addition, in order to suppress adhesion of the precipitated particles dispersed in the liquid to the side wall of the channel of mixing channel portion 107 and/or stagnation channel portion 108, the surface roughness of the side wall inner surface of the cross section of the channel is preferably larger than the surface roughness of glass plate 201 and the surface roughness of vibrating plate 203 as the upper and lower inner surfaces.

Next, as vibrating plate 203, a SUS316L plate having a thickness of, for example, 0.2 mm is employed in order to secure strength and chemical resistance.

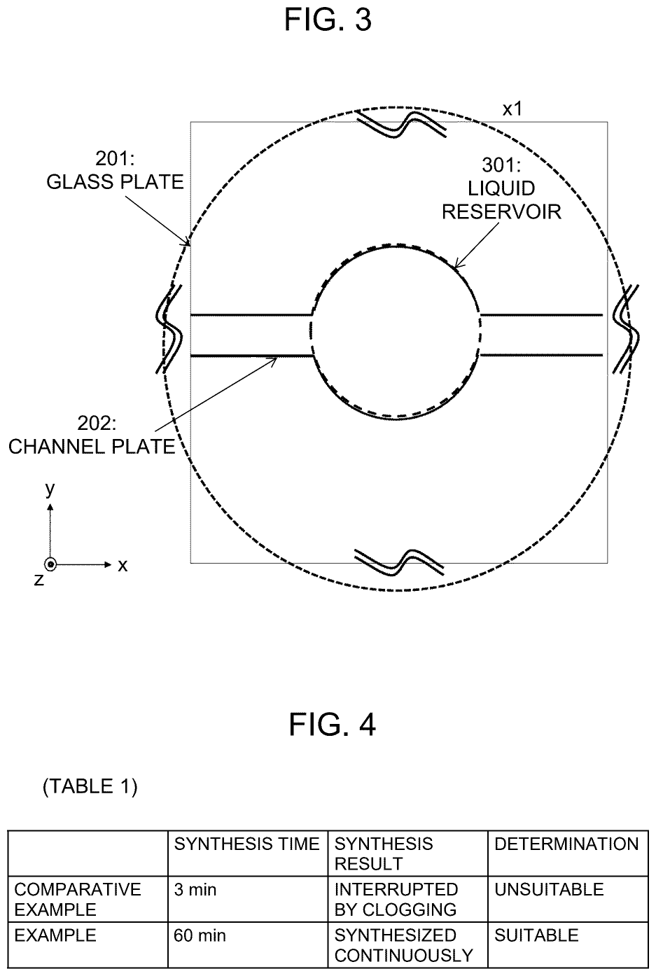

FIG. 3 is a top view of the x1 part of the mixer in the flow synthesis device according to the first exemplary embodiment. The x1 part is the upper surface of vibration applying unit 104a and is the channel of mixing channel portion 107. In addition, in the x1 part, the channel of mixing channel portion 107 includes liquid reservoir 301 whose width in the Y direction becomes larger than channel width Y of the normal channel along the flow direction (the X direction). Liquid reservoir 301 has a circular cross section having the same shape as that of vibration applying unit 104a in the vertical direction (the Z direction). The lower surface of liquid reservoir 301 is vibrating plate 203, and vibrating plate 203 is in contact with vibration applying unit 104a vertically downward. Here, “the same shape as that of vibration applying unit 104a” means, for example, “the projected shape of vibration applying unit 104a onto the lower surface of mixing channel portion 107”. When vibration applying unit 104a is, for example, a ceramic ball having a size of q 2.5 mm as described above, the projected shape is also a circular shape having a diameter of 2.5 mm. Therefore, liquid reservoir 301 may have, for example, a cylindrical shape having a diameter of 4 mm in the vertical direction.

In order to suppress a case where the particles grown in the liquid and aggregates of the particles are deposited on vibrating plate 203 to cause clogging, the displacement amount of the lower surface of mixing channel portion 107 due to vibration applying mechanism 105 is preferably large. In addition, in order to convert the thrust due to the resonance of vibration applicator 104b into the displacement amount of the lower surface of mixing channel portion 107, channel plate 202 preferably has a hole having the same shape as that of vibration applying unit 104a and having a size a little bit larger than that of vibration applying unit 104a, as liquid reservoir 301, as illustrated in FIG. 3.

In the first exemplary embodiment, since a ceramic ball having a size of φ2.5 mm is employed as vibration applying unit 104a as described above, liquid reservoir 301 has a hole diameter of φ4 mm in the XY plane.

The flow synthesis device according to the first exemplary embodiment was experimentally produced, and a particle-containing liquid of a zeolite-imidazolate framework (ZIF), which is a kind of a metal organic framework (MOF), for example, ZIF-8, was produced while the particle-containing liquid was continuously evaluated.

Hereinafter, this will be described in detail.

### EXAMPLE

An aqueous solution of zinc nitrate (40 mM) and an aqueous solution of 2-methylimidazole (2400 mM) were prepared as raw materials of a particle-containing liquid of ZIF-8, and fed by using two plunger pumps as liquid feeder 102 such that the flow rate of each aqueous solution was 2 mL/min to produce a particle-containing liquid for a continuous liquid feeding time of 60 minutes.

On the upstream side of mixer 103 as described above, a tube having an inner diameter of 1 mm and made of PAF (perfluoroalkoxyethylene) was connected to two plunger pumps, and on the downstream side, a tube having an inner diameter of 1 mm and made of PAF was connected to recover the particle-containing liquid.

Here, during continuous liquid feeding, vibration applying mechanism 105 as described above was employed to apply vibration at a frequency of 10 kHz under a driving voltage of 16 V of a laminated piezoelectric actuator, thereby displacing vibrating plate 203 by 2 μm.

### COMPARATIVE EXAMPLE

In the same manner as in Example, an aqueous solution of zinc nitrate (40 mM) and an aqueous solution of 2-methylimidazole (2400 mM) were prepared as raw materials of a particle-containing liquid of ZIF-8, and fed by using two plunger pumps as liquid feeder 102 such that the flow rate of each aqueous solution was 2 mL/min to produce a particle-containing liquid.

For mixing the raw materials, a three-way joint having an inner diameter of 0.3 mm manufactured by FLOM Corporation was used. On the upstream side, a tube having an inner diameter of 1 mm and made of PAF was connected to two plunger pumps, and on the downstream side, a tube having an inner diameter of 1 mm and made of PAF was connected to recover the particle-containing liquid.

FIG. 4 is Table 1 showing the synthesis conditions and evaluation results of Comparative Example and Example. The experimental results will be described with reference to Table 1 in FIG. 4.

In Comparative Example, continuous liquid feeding became impossible due to pressure abnormality of the plunger pump after a synthesis time of 3 minutes. As checked after verification, it was suggested that the downstream side of the three-way joint and the connection portion between the downstream side of the three-way joint and the PAF tube were clogged with the precipitated particles therein, leading to the above-described pressure abnormality. The flow synthesis device of Comparative Example is unsuitable for the continuous synthesis of a particle-containing liquid.

On the other hand, in Example, the particle-containing liquid can be continuously produced for a liquid feeding time of 60 minutes, and the particle size distribution evaluation of the particle-containing liquid proved that monodispersed particles were synthesized. The flow synthesis device of Example is suitable for the continuous synthesis of a particle-containing liquid.

Thus, it has been indicated that the flow synthesis device according to the first exemplary embodiment of the present disclosure was capable of both securing mixing property and suppressing clogging even with a material whose time from a nucleation phase to a growth phase in a particle formation process is short.

### INDUSTRIAL APPLICABILITY

According to the flow synthesis device of the present disclosure, particles having a uniform particle diameter can be stably produced even with a material whose time from a nucleation phase to a growth phase in a particle formation process is short. Therefore, the present invention can be applied to various applications other than the particle manufacturing process, such as a polymer material having a high thickening rate during synthesis.

### REFERENCE MARKS IN THE DRAWINGS

101 flow synthesis device
102 liquid feeder
103 mixer
104a vibration applying unit
104b vibration applicator
105 vibration applying mechanism
106 raw material supply unit
107 mixing channel portion
108 stagnation channel portion
201 glass plate
202 channel plate
203 vibrating plate
301 liquid reservoir

1. A flow synthesis device that synthesizes a compound by mixing a plurality of fluids, the flow synthesis device comprising:
a raw material supply unit through which the plurality of fluids are suppled;
a mixing channel portion in which the plurality of fluids supplied from the raw material supply unit are mixed to be a synthesized compound;
a stagnation channel portion in which the synthesized compound stagnates, the stagnation channel portion being connected in series with a downstream end of the mixing channel portion; and
a vibration applying mechanism that applies vibration to the mixing channel portion from a vertically lower side to a vertically upper side, the vibration applying mechanism being provided only to a part of a lower surface of the mixing channel portion.

2. The flow synthesis device according to claim 1, wherein each of the raw material supply unit and the mixing channel portion has a cross section having a rectangular shape.

3. The flow synthesis device according to claim 1, wherein the stagnation channel portion has a larger cross-sectional area than a cross-sectional area of the mixing channel portion.

4. The flow synthesis device according to claim 1, wherein the stagnation channel portion is connected from the vertically lower side to the vertically upper side the downstream end of the mixing channel portion.

5. The flow synthesis device according to claim 1, wherein each of the raw material supply unit and the mixing channel portion has a channel width and a channel depth, and
a ratio Z/Y satisfies 1<Z/Y<10 when Y is in a range of 0.1 mm to 5 mm,
where Y represents the channel width of each of the raw material supply unit and the mixing channel portion, and
Z represents the channel depth of each of the raw material supply unit and the mixing channel portion.

6. The flow synthesis device according to claim 1, wherein
the vibration applying mechanism includes a vibration applying unit to apply the vibration, and
the mixing channel portion includes a liquid reservoir having a cross section identical to a cross section of the vibration applying unit in shape as viewed in a direction intersecting a flow direction of the plurality of fluids, the liquid reservoir being provided above the vibration applying mechanism.

7. The flow synthesis device according to claim 1, wherein
the mixing channel portion is defined by upper and lower inner surfaces and side inner surfaces of a cross section of the mixing channel portion, and
the side inner surfaces have a larger surface roughness than a surface roughness of the upper and lower inner surfaces.
